(19) United States
(12) Patent Application Publication
(10) Pub. No.: US 2008/0191982 A1
(43) Pub. Date: Aug. 14, 2008

(54) DISPLAY DEVICE

(76) Inventor: Kyoung-Don Lee, Suwon-si (KR)

Correspondence Address: F. CHAU & ASSOCIATES, LLC, 130 WOODBURY ROAD, WOODBURY, NY, 11797, US

(21) Appl. No.: 12/017,967

(22) Filed: Jan. 22, 2008

(30) Foreign Application Priority Data
Feb. 14, 2007 (KR) 2007-15133

(51) Int. Cl. G09G 3/36

(52) U.S. Cl. 345/87

(57) ABSTRACT

A display device includes a light-providing part, a first display panel part disposed at a first side of the light-providing part, a second display panel part disposed at a second side of the light-providing part, a receiving part disposed between the second display panel part and the light-providing part and a film member disposed between the second display panel part and the receiving part. The film member has an opening formed corresponding to the second display panel part. The film member reduces the amount of reflected light that is directed to the first side of the light-providing part. Thus, the display device has a simplified structure and improved display quality.

### CROSS-REFERENCE TO RELATED APPLICATION

The present application claims priority to Korean Patent Application No. 2007-15133, filed on Feb. 14, 2007, the contents of which are herein incorporated by reference in their entirety.

### BACKGROUND OF THE INVENTION

1. Technical Field

The present invention relates to a display device. More particularly, the present invention relates to a display device having two displays.

2. Discussion of the Related Art

A liquid crystal display (LCD) device as a type of flat panel display device displays an image using electrical and optical characteristics of liquid crystals.

Nowadays, an LCD device having two displays is used, for example, in small-sized LCD devices. The LCD device includes a main LCD panel and a sub-LCD panel that has a size smaller than the main LCD panel.

In a conventional LCD device having two displays, a chassis is disposed corresponding to the sub-LCD panel. For example, the sub-LCD panel is positioned corresponding to an opening formed through the chassis. Here, a shape of the opening corresponding to the sub-LCD panel is displayed on the main LCD panel, thereby deteriorating the display quality of the LCD device.

### SUMMARY OF THE INVENTION

Embodiments of the present invention provide a display device capable of improving the display quality of a display panel.

A display device, according to an embodiment of the present invention, includes a light-providing part, a first display panel part, a second display panel part, a receiving part and a film member. The light-providing part provides light toward a first side and a second side opposite to the first side. The first display panel part is disposed at the first side of the light-providing part to display a first image using the light directed to the first side of the light-providing part. The second display panel part is disposed at the second side of the light-providing part to display a second image using the light directed to the second side of the light-providing part. The second image is smaller than the first image. The receiving part is disposed between the second display panel part and the light-providing part to receive the light-providing part and the first display panel part. The film member is disposed between the second display panel part and the receiving part to reduce the amount of reflected light that is directed to the first side of the light-providing part. The reflected light is the light that was originally directed to the second side of the light-providing part and then reflected. The film member has an opening formed corresponding to the second display panel part.

In an exemplary embodiment, the film member may have a coupling area formed adjacent to the opening and corresponding to a peripheral portion of the second display panel part. The coupling area of the film member may be coupled to the peripheral portion of the second display panel part through an adhesive member. The display device may further include an alignment member formed adjacent to the coupling area to guide at least one side of the second display panel part.

For example, the second display panel part may include a display panel displaying the second image and a mold frame configured to receive the display panel. The coupling area of the film member may be coupled to a peripheral portion of the mold frame receiving the display panel.

The film member may be colored to reduce the amount of the reflected light directed to the first side of the light-providing part. The film member may include a black color or a gray color.

The film member and the receiving part may be coupled to each other through an adhesive member.

In an exemplary embodiment, the display device may further include an optical member disposed between the receiving part and the film member to improve optical characteristics of the light directed to the second side of the light-providing part. The optical member may have a coupling area corresponding to a peripheral portion of the second display panel part. For example, the coupling area of the optical member may be coupled to the peripheral portion of the second display panel part through an adhesive member.

A display device, according to an embodiment of the present invention, includes a backlight assembly, a first display panel, a second display panel, a first mold frame and a film member. The backlight assembly provides light toward a first side and a second side opposite to the first side. The first display panel is disposed at the first side of the backlight assembly to display a first image using the light directed to the first side of the backlight assembly. The second display panel is disposed at the second side of the backlight assembly to display a second image using the light directed to the second side of the backlight assembly. The second image is smaller than the first image. The first mold frame is disposed between the second display panel and the backlight assembly to receive the backlight assembly and the first display panel. The film member is disposed between the second display panel and the first mold frame to reduce the amount of reflected light that is directed to the first side of the backlight assembly. The reflected light is the light originally directed to the second side of the backlight assembly and then reflected. The film member has an opening formed corresponding to the second display panel.

In an exemplary embodiment, the film member may have a coupling area corresponding to a peripheral portion of the second display panel to be coupled to the peripheral portion of the second display panel.

In an exemplary embodiment, the display device may further include a second mold frame configured to receive the second display panel. The film member may have a coupling area corresponding to a peripheral portion of the second mold frame to be coupled to the peripheral portion of the second mold frame.

According to embodiments of the present invention, a film member reduces the amount of reflected light that is directed to a first side of a light-providing part. Thus, the display quality of a display device may be improved, and a chassis may be omitted to simplify a structure of a display device.

### BRIEF DESCRIPTION OF THE DRAWINGS

Exemplary embodiments of the present invention can be understood in more detail from the following description taken in conjunction with the accompanying drawings, in which:

FIG. 1 is an exploded perspective view illustrating a display device according to an exemplary embodiment of the present invention;

FIG. 2 is a cross-sectional view taken along a line I-I′ in FIG. 1;

FIG. 3 is a cross-sectional view illustrating a coupling of the second display panel and the film member of the display device illustrated in FIG. 1;

FIG. 4 is a perspective view illustrating a coupling of the film member and the mold frame of the display device illustrated in FIG. 1;

FIG. 5 is a perspective view illustrating a coupling of a second display panel and a film member of a display device according to an exemplary embodiment of the present invention;

FIG. 6 is a perspective view illustrating a coupling of a second display panel and a film member of a display device according to an exemplary embodiment of the present invention; and

FIG. 7 is a perspective view illustrating a coupling of a second display panel and an optical member of a display device according to an exemplary embodiment of the present invention.

### DESCRIPTION OF EXEMPLARY EMBODIMENTS

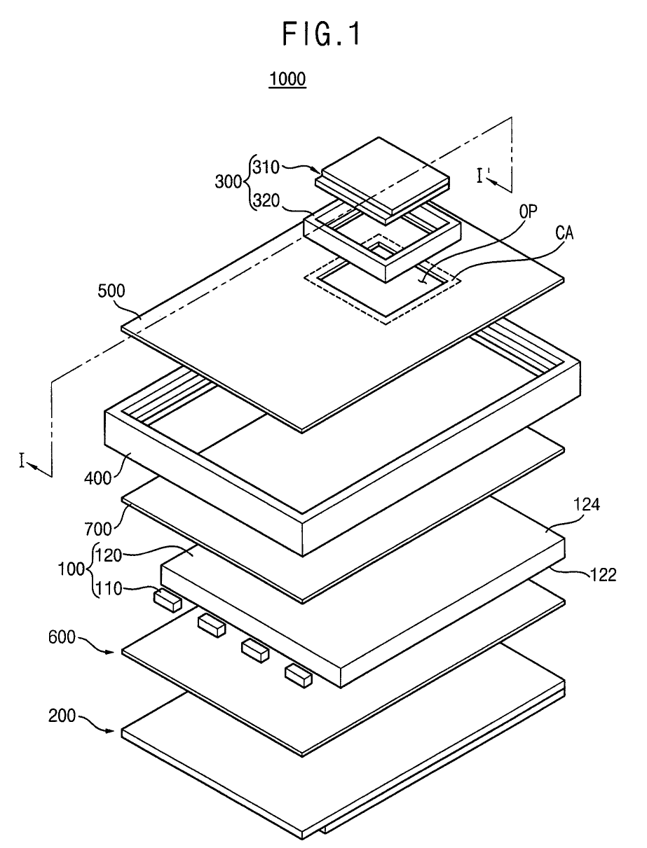

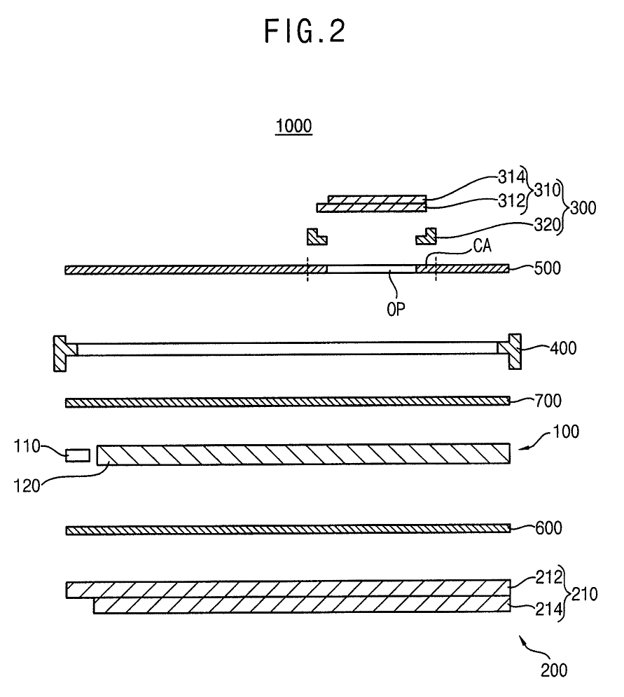

Exemplary embodiments of the invention are described more fully hereinafter with reference to the accompanying drawings. This invention may, however, be embodied in many different forms and should not be construed as limited to the embodiments set forth herein. In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. FIG. 1 is an exploded perspective view illustrating a display device according to an exemplary embodiment of the present invention. FIG. 2 is a cross-sectional view taken along a line I-I′ in FIG. 1.

Referring to FIGS. 1 and 2, a display device 1000 includes a light-providing part 100, a first display panel part 200, a second display panel part 300, a receiving part 400 and a film member 500.

The light-providing part 100 provides light toward a first side and a second side opposite to the first side, and includes a light source 110 and a light-guiding member 120.

The light source 110 generates light. For example, the light source 110 includes a light-emitting diode (LED). The light source 110 may include a white LED generating white light.

The light-guiding member 120 horizontally guides the light generated from the light source 110. First light exits the light-guiding member 120 through a first light-exiting face 122 toward the first side. Second light exits the light-guiding member 120 through a second light-exiting face 124toward the second side.

The first display panel part 200 is disposed at the first side of the light-providing part 100, and displays a first image using the first light directed to the first side.

The second display panel part 300 is disposed at the second side of the light-providing part 100, and displays a second image using the second light directed to the second side. The second image is smaller than the first image.

The first display panel part 200 includes a first display panel 210, and the second display panel part 300 includes a second display panel 310.

The first display panel 210 includes a first substrate 212 and a second substrate 214, and the second display panel 310 includes a first substrate 312 and a second substrate 314. In an exemplary embodiment, the first substrates 212 and 312 may correspond to a thin-film transistor (TFT) substrate having a TFT, and the second substrates 214 and 314 may correspond to a color filter substrate having a color filter. A liquid crystal layer (not shown) is interposed between the first substrates 212 and 312 and the second substrates 214 and 314, respectively.

The receiving part 400 is disposed between the second display panel part 300 and the light-providing part 100, and receives the light-providing part 100 and the first display panel part 200. The receiving part 400 also receives a film member 500, which will be described in more detail below. As shown in FIG. 1, the receiving part 400 is a mold frame having a frame shape.

The film member 500 receives the second display panel part 300 in an opening OP formed corresponding to the second display panel part 300. The film member 500 is disposed in the receiving part 400.

A portion of the second light that is generated from the light-providing part 100 and directed to the second side passes through the opening OP and arrives at the second display panel 310. Another portion of the second light arrives at the film member 500.

Most of the light arriving at the second display panel 310 is used to display an image on the second display panel 310, and a small portion of the light is reflected toward the first side. The light arriving at the film member 500, except for the opening OP, is partially absorbed by the film member 500, and partially reflected from the film member 500.

The film member 500 reduces the amount of the reflected light directed to the first side of the light-providing part 100. The reflected light is the light originally directed to the second side of the light-providing part 100, which is then reflected from the film member 500 and the second display panel 310. As a result, the difference between the amount of the light reflected from the film member 500 and the amount of the light reflected from the second display panel 310 is small, so that an image displayed on the first display panel 210 has uniform luminance, thereby preventing a shape of the opening OP from being displayed on the first display panel 210. Therefore, the display quality of the display device 1000 may be improved.

The film member 500 may include, for example, polyethylene terephthalate (PET).

Since the display device 1000 employs the film member 500 to define a configuration of the display device 1000, a chassis included in a conventional display device may be omitted to thereby simplify a structure of the display device 1000.

The film member 500 may be colored to reduce the amount of the reflected light directed to the first side of the light-providing part 100. Optical reflectivity of the light arriving at the film member 500 may vary in accordance with colors. Thus, the film member 500 may have a dark color to reduce the amount of the reflected light directed to the first side of the light-providing part 100. For example, the film member 500 may include a black color or a gray color.

The display device 1000 may selectively include a first optical member 600 and/or a second optical member 700.

The first and second optical members 600 and 700 improve optical characteristics of the first and second lights directed to the first and second sides of the light-providing part 100, respectively. For example, each of the first and second optical members 600 and 700 may include a light-diffusing sheet, a prism sheet, a dual brightness enhancement film (DBEF), etc.

The light-diffusing sheet enhances luminance uniformity, the prism sheet improves a viewing angle, and the DBEF increases luminance and a viewing angle.

In FIGS. 1 and 2, the first optical member 600 is disposed under the receiving part 400. Alternatively, the first optical member 600 may be disposed over the receiving part 400.

The film member 500 includes the opening OP, and has a coupling area CA corresponding to a peripheral portion of the second display panel part 300 to be coupled to the peripheral portion of the second display panel part 300. Thus, the second display panel part 300 may be coupled to the film member 500 at the coupling area CA.

Hereinafter, a coupling of the second display panel part 300 and the film member 500 will be described in more detail with reference to the accompanying drawings.

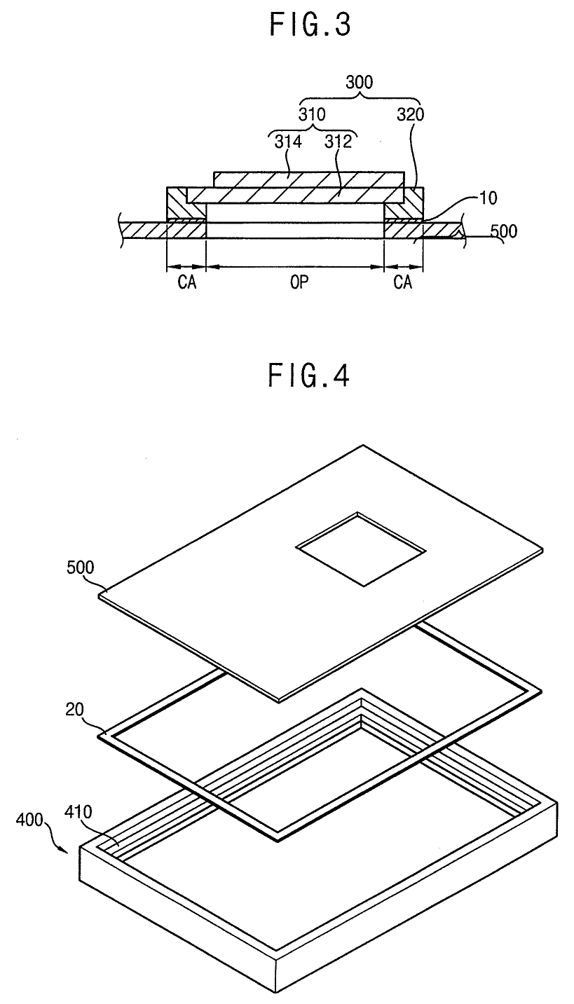

FIG. 3 is a cross-sectional view illustrating a coupling of the second display panel and the film member of the display device illustrated in FIG. 1.

Referring to FIG. 3, the second display panel part 300 includes the second display panel 310 and a mold frame 320. The mold frame 320 receives the second display panel 310.

As shown in FIG. 3, the mold frame 320 is coupled to the coupling area CA of the film member 500. For example, a peripheral portion of the mold frame 320 corresponds to the coupling area CA, and the coupling area CA is coupled to the peripheral portion of the mold frame 320. Also, the coupling area CA of the film member 500 is coupled to the peripheral portion of the mold frame 320 through an adhesive member 10. The adhesive member 10 may include, for example, double-sided tape.

The film member 500 including the coupling area CA does not overlap an effective display area of the second display panel 310. Thus, the effective display area of the second display panel 310 is not substantially reduced by the film member 500.

In FIGS. 1 to 3, the coupling area CA is formed adjacent to the opening OP having, for example, a quadrangular shape and corresponding to four sides of the quadrangular shape. Alternatively, the coupling area CA may be formed adjacent to the opening OP and corresponding to one side, two sides or three sides of the quadrangular shape.

FIG. 4 is a perspective view illustrating a coupling of the film member and the mold frame of the display device illustrated in FIG. 1.

Referring to FIG. 4, the receiving part 400 includes a stepped portion 410 to receive and support the film member 500.

The film member 500 and the receiving part 400 may be coupled to each other through an adhesive member 20. For example, the peripheral portion of the film member 500 is coupled to the stepped portion 410 of the receiving part 400 through the adhesive member 20. Thus, the film member 500 may be prevented from separating from the receiving part 400 and moving freely.

The adhesive member 20 may include, for example, double-sided tape.

FIG. 5 is a perspective view illustrating a coupling of a second display panel and a film member of a display device according to an exemplary embodiment of the present invention. Referring to FIG. 5, the display device includes an alignment member 510 formed on a film member 500.

The alignment member 510 is formed adjacent to the coupling area CA to guide at least one side of the second display panel part 300. Thus, the alignment member 510 may align the second display panel part 300 at a more exact position than if no alignment member were used. In an exemplary embodiment, the alignment member 510 guides face two sides of the mold frame 320. Thus, when the second display panel part 300 is installed in the display device, the alignment member 510 guides the second display panel part 300 to be disposed at an exact position.

In FIG. 5, the alignment member 510 is disposed adjacent to two sides of a quadrangular shape defined by the coupling area CA. Alternatively, the alignment member 510 may be disposed adjacent to one side, three sides or four sides of the quadrangular shape defined by the coupling area CA.

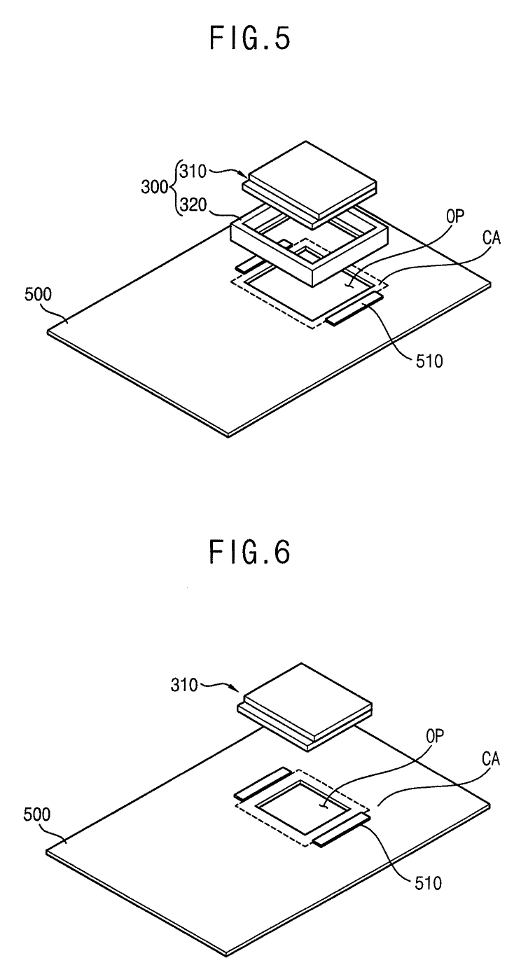

FIG. 6 is a perspective view illustrating a coupling of a second display panel and a film member of a display device according to an exemplary embodiment of the present invention. Referring to FIG. 6, a second display panel part 300 of the display device does not include a mold frame 320. Thus, the second display panel part 300 is disposed directly on the film member 500.

As shown in FIG. 6, a second display panel 310 of the second display panel part 300 is coupled to a coupling area CA of the film member 500. For example, a peripheral portion of the second display panel 310 corresponds to the coupling area CA, and the coupling area CA is coupled directly to the peripheral portion of the second display panel 310. The coupling area CA of the film member 500 may be coupled to the peripheral portion of the second display panel 310 through an adhesive member (not shown). The adhesive member may include, for example, double-sided tape.

Since the mold frame 320 is omitted, the opening OP illustrated in FIG. 6 may be smaller than the opening OP illustrated in FIGS. 1 to 5.

As shown in FIG. 6, an alignment member 510 may be formed on the film member 500.

The alignment member 510 is formed adjacent to the coupling area CA to guide at least one side of the second display panel part 300. In an exemplary embodiment, the alignment member 510 guides face two sides of the second display panel 310 of the second display panel part 300. Thus, when the second display panel part 300 is installed in the display device, the alignment member 510 guides the second display panel part 300 to be disposed at an exact position.

In FIG. 6, the alignment member 510 is formed on the film member 500. Alternatively, the alignment member 510 may be omitted.

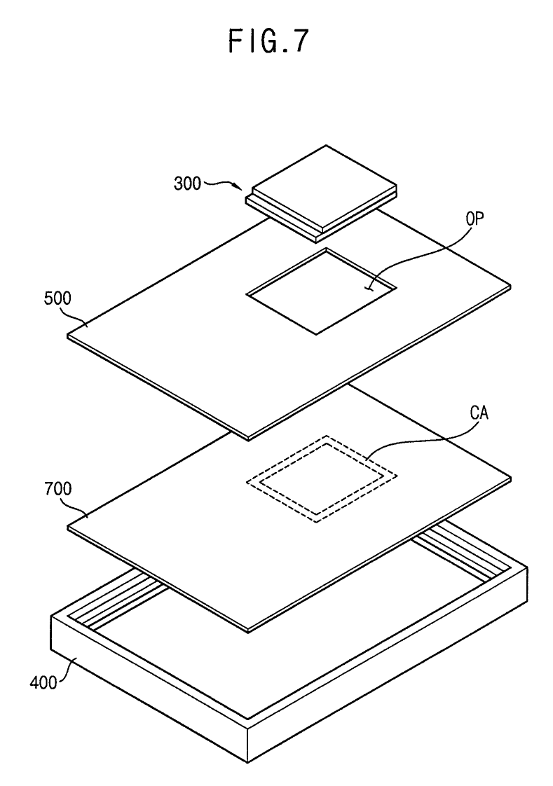

FIG. 7 is a perspective view illustrating a coupling of a second display panel and an optical member of a display device according to an exemplary embodiment of the present invention.

Referring to FIG. 7, a second optical member 700 of the display device is disposed between the film member 500 and the receiving part 400 to be received in the receiving part 400.

The second optical member 700 has a coupling area CA corresponding to the peripheral portion of the second display panel part 300 to be coupled to the peripheral portion of the second display panel part 300. The coupling area CA of the second optical member 700 may be coupled to the peripheral portion of the second display panel part 300 through an adhesive member (not shown). The adhesive member may include, for example, double-sided tape.

In FIG. 7, the second display panel part 300 employs the second display panel part 300 illustrated in FIG. 6. Alternatively, the second display panel part 300 may employ the second display panel part 300 illustrated in FIGS. 1 to 3.

According to the embodiments of the present invention, a film member reduces the amount of reflected light that is directed to a first side of a light-providing part. Thus, the difference between the amount of the reflected light from the film member and the amount of reflected light from a second display panel may be decreased.

Accordingly, an image displayed on a first display panel has uniform luminance, and a shape of an opening corresponding to the second display panel may be prevented from being displayed on the first display panel. Thus, the display quality of a display device may be improved.

In addition, since the film member defines a configuration of the display device, a chassis included in a conventional display device may be omitted to thereby simplify a structure of the display device.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a light-providing part to provide light toward a first side and a second side opposite to the first side;
a first display panel part disposed at the first side of the light-providing part to display a first image using the light directed to the first side of the light-providing part;
a second display panel part disposed at the second side of the light-providing part to display a second image using the light directed to the second side of the light-providing part, the second image being smaller than the first image;
a receiving part disposed between the second display panel part and the light-providing part to receive the light-providing part and the first display panel part; and
a film member disposed between the second display panel part and the receiving part to reduce an amount of reflected light directed to the first side of the light-providing part, the film member having an opening formed corresponding to the second display panel part.

2. The display device of claim 1, wherein the film member has a coupling area formed adjacent to the opening and corresponding to a peripheral portion of the second display panel part

3. The display device of claim 2, wherein the coupling area of the film member is coupled to the peripheral portion of the second display panel part through an adhesive member.

4. The display device of claim 2, further comprising an alignment member formed adjacent to the coupling area to guide at least one side of the second display panel part.

5. The display device of claim 2, wherein the second display panel part comprises:
a display panel displaying the second image; and
a mold frame configured to receive the display panel, wherein the coupling area of the film member is coupled to a peripheral portion of the mold frame.

6. The display device of claim 1, wherein the film member is colored to reduce the amount of the reflected light directed to the first side of the light-providing part.

7. The display device of claim 6, wherein the film member includes a black color or a gray color.

8. The display device of claim 1, wherein the film member and the receiving part are coupled to each other through an adhesive member.

9. The display device of claim 1, further comprising an optical member disposed between the receiving part and the film member,
wherein the optical member has a coupling area corresponding to a peripheral portion of the second display panel part.

10. The display device of claim 9, wherein the coupling area of the optical member is coupled to the peripheral portion of the second display panel part through an adhesive member.

11. A display device comprising:
a backlight assembly to provide light toward a first side and a second side opposite to the first side;
a first display panel disposed at the first side of the backlight assembly to display a first image using the light directed to the first side of the backlight assembly;
a second display panel disposed at the second side of the backlight assembly to display a second image using the light directed to the second side of the backlight assembly, the second image being smaller than the first image;
a first mold frame disposed between the second display panel and the backlight assembly to receive the backlight assembly and the first display panel; and
a film member disposed between the second display panel and the first mold frame to reduce amount of reflected light directed to the first side of the backlight assembly, the film member having an opening formed corresponding to the second display panel.

12. The display device of claim 11, wherein the film member has a coupling area corresponding to a peripheral portion of the second display panel.

13. The display device of claim 12, wherein the film member is coupled to the peripheral portion of the second display panel through an adhesive member.

14. The display device of claim 12, further comprising an alignment member formed adjacent to the coupling area to guide at least one side of the second display panel.

15. The display device of claim 11, wherein the film member is colored to reduce the amount of reflected light directed to the first display panel.

16. The display device of claim 15, wherein the film member includes a black color or a gray color.

17. The display device of claim 11, further comprising a second mold frame to receive the second display panel, wherein the film member has a coupling area corresponding to a peripheral portion of the second mold frame.

18. The display device of claim 17, wherein the film member is coupled to the peripheral portion of the second mold frame through an adhesive member.

19. The display device of claim 17, further comprising an alignment member formed adjacent to the coupling area to guide at least one side of the second mold frame.

20. The display device of claim 11, wherein the film member and the first mold frame are coupled to each other through an adhesive member.
